(19) United States
(12) Patent Application Publication
(10) Pub. No.: US 2025/0198325 A1
(43) Pub. Date: Jun. 19, 2025

(54) EXPANSION TANK

(71) Applicant: MAHLE International GmbH, Stuttgart (DE)

(72) Inventors: Ralf Zink, Stuttgart (DE); Markus Lang, Loechgau (DE); Kai Saupe, Boeblingen (DE)

(21) Appl. No.: 18/979,587

(22) Filed: Dec. 12, 2024

(30) Foreign Application Priority Data
Dec. 15, 2023 (DE) 10 2023 135 283.0

(51) Int. Cl. F01P 11/02; F01P 3/00; F01P 3/12

(52) U.S. Cl. CPC F01P 11/029; F01P 3/12; F01P 2003/006

(57) ABSTRACT

An expansion tank for a battery cooling system is disclosed. The expansion tank includes a tank housing, an exchangeable dryer insert with a housing and drying agent arranged therein, a lid which can be connected to the tank housing and in which the dryer insert is at least partially accommodated, and a valve device and/or a diaphragm. Via the valve device and/or the diaphragm, air passes from the expansion tank into the environment when there is an overpressure in the expansion tank and fresh air passes from the environment into the expansion tank when there is a vacuum in the expansion tank.

### CROSS-REFERENCE TO RELATED APPLICATIONS

This application claims priority to German Patent Application No. DE 10 2023 135 283.0 filed on Dec. 15, 2023, the contents of which are hereby incorporated by reference in their entirety.

### TECHNICAL FIELD

The present invention relates to an expansion tank for a battery cooling system. The invention also relates to a battery cooling system with such an expansion tank.

### BACKGROUND

Electric or hybrid vehicles are increasingly becoming the focus of consumers due to environmental aspects and are therefore also becoming more widespread on the roads. In order to be able to increase both the range and the performance of such electric or hybrid vehicles, the aim is to keep a traction battery of such an electric or hybrid vehicle in an optimum temperature window for this traction battery, for which temperature control devices, in particular cooling devices, are used in a known manner. In order to achieve particularly efficient cooling, so-called immersion cooling is also used, in which a dielectric, i.e., electrically non-conductive, coolant flows around individual battery cells of the traction battery.

Such a battery cooling system for cooling a traction battery in particular also includes an expansion tank in which air is stored as an expansion cushion for a temperature-related change in volume of the coolant. However, an increase in temperature causes the coolant in the expansion tank to expand, which could lead to a high pressure load in the expansion tank and possibly damage it if the resulting excess pressure cannot escape and should therefore be avoided. For this reason, such expansion tanks usually have a connection to the environment in order to be able to reduce a temperature-related pressure difference if necessary. When the coolant cools down, it contracts, creating a vacuum in the expansion tank, which leads to fresh air being drawn in from the environment. In order to prevent or at least reduce the undesirable introduction of moisture into the coolant, so-called dryer cartridges have been provided to date, in which a drying agent was arranged, through which the fresh air drawn in from the environment flowed, absorbing moisture and drying the fresh air drawn in.

However, the disadvantage of such dryer cartridges is that they have a sheet metal housing with the drying agent inside and are therefore not only heavy, but also require a comparatively complicated connection to a plastic tank housing of an expansion tank. In addition, the processing of sheet metal and the raw material sheet metal are expensive and the design of the dryer cartridge as a disposable part is ecologically problematic.

The present invention therefore deals with the problem of providing an improved or at least an alternative embodiment for an expansion tank, by means of which the disadvantages known from the prior art can be overcome.

According to the invention, this problem is solved by the object of the independent claim(s). Advantageous embodiments are the object of the dependent claims.

### SUMMARY

The present invention is based on the general idea of forming a replaceable dryer insert with a housing, in particular a plastic housing, a housing made of fleece, or a natural fiber housing, and drying agent arranged therein, but without a thread via which the dryer insert is screwed to a tank housing of an expansion tank, such that an overall weight-optimized solution can be found which is significantly more advantageous in terms of a connection, since the dryer insert is now held via a lid which can be connected to the tank housing of the expansion tank, in particular a screw-on lid. The expansion tank for air in a battery cooling system according to the invention has the aforementioned tank housing as well as a replaceable dryer insert with the housing and the drying agent arranged therein. Furthermore, the expansion tank has a lid which can be connected to the tank housing, in particular screwed on, and in which the dryer insert is at least partially accommodated. The expansion tank is used to buffer a volume of air due to a temperature-related change in the volume of a cooling medium, in particular oil. The dryer insert is therefore no longer attached to the tank housing of the expansion tank for air in a battery cooling system via a metal nipple, which is difficult to manufacture, but via the lid, which can be used for all dryer inserts over the service life of the expansion tank, thus reducing the amount of waste when replacing the dryer insert. The expansion tank also has a valve device and/or a diaphragm via which air from the expansion tank is released into the environment when there is excess pressure in the expansion tank and fresh air from the environment is released into the expansion tank when there is negative pressure in the expansion tank. Fresh air is naturally drawn in via the drying agent of the dryer insert when there is negative pressure in the expansion tank in order to reliably prevent the undesired entry of moisture into the expansion tank and into a dielectric coolant stored there. Excessive moisture in the dielectric coolant could make it conductive under certain circumstances, which could lead to a short circuit. The expansion tank according to the invention enables the use of a dryer insert with a housing, in particular a plastic housing, a housing made of fleece, or a natural fiber housing, with a significantly lower weight, since the dryer insert itself can have a comparatively thin and thus light housing, which only has the task of holding the drying agent arranged therein. The lid, which, like the tank housing of the expansion tank, is preferably made of plastic, is a so-called service life component that is used over the entire service life of the expansion tank and, unlike the dryer insert, does not need to be replaced. The expansion tank according to the invention can also reduce the amount of waste when changing the dryer insert, as it does not have a comparatively heavy housing made of metal, in particular sheet metal, as was previously the case. Overall, the dryer insert can also be designed to be more cost-effective, as the housing used, in particular the plastic housing, the housing made of fleece, or the natural fiber housing, is significantly simpler and therefore cheaper to manufacture. The previously used sheet metal housing, which in particular also required a connection geometry, for example a metallic threaded nipple for screwing a previous dryer cartridge with sheet metal housing to the tank housing, can be dispensed with.

In a further advantageous embodiment of the expansion tank according to the invention, the dryer insert has an activated carbon section. The activated carbon section is able to bind pollutants, in particular hydrocarbons, such that when there is excess pressure in the expansion tank, air is usually blown out via the activated carbon section of the dryer insert, wherein the air blown out is purified. Such an activated carbon section with activated carbon is already well known and is used, for example, in fuel filters.

In a further advantageous embodiment of the solution according to the invention, the valve device and/or the diaphragm is/are designed and arranged in such a way that when there is positive pressure in the expansion tank, air passes into the environment via the activated carbon section and when there is negative pressure in the expansion tank, fresh air passes from the environment through the drying agent into the expansion tank. This allows the fresh air drawn in to be dried and the air blown out to be cleaned. Alternatively, it is also conceivable that the valve device and/or the diaphragm is/are designed and arranged in such a way that, when there is positive pressure in the expansion tank, air passes through the activated carbon section and the drying agent into the environment and, when there is negative pressure in the expansion tank, fresh air from the environment passes through the drying agent and the activated carbon section into the expansion tank. In this case, the activated carbon section and the drying agent are therefore not connected in parallel, but in series, such that cleaning and drying take place both when fresh air is drawn in from the environment and when air is blown out into the environment. By connecting the drying agent and the activated carbon section in series, it is also possible to actively dry the drying agent and clean the activated carbon section. If, for example, dry air is blown out through the activated carbon section and the drying agent when there is excess pressure in the expansion tank, pollutants such as hydrocarbons are retained in the activated carbon section, but the drying agent is dried again due to the dry air flowing through it and thus regenerated. If there is negative pressure in the expansion tank, the activated carbon section is flushed with fresh air/ambient air from the environment and thus cleaned.

In a further advantageous embodiment of the expansion tank according to the invention, the drying agent and/or the activated carbon section are bounded by a fleece layer. A fleece layer of this type enables a clear separation between the drying agent and the activated carbon on the one hand and an almost unhindered air flow on the other, which significantly reduces flow resistance compared to a plastic grid, for example. Of course, the housing of the dryer insert can also be made of such fleece layers.

In a further preferred embodiment of the expansion tank according to the invention, the valve device and/or the diaphragm is/are arranged on the dryer insert or on the expansion tank. If the valve device or the diaphragm is arranged on the expansion tank, there is the great advantage that the valve device or the diaphragm can remain on the expansion tank or its tank housing as a service life component, such that the dryer insert only has to be disposed of or replaced with its housing and the drying agent arranged in it. If the valve device or the diaphragm is arranged on the dryer insert, there is the advantage that these components are also replaced at regular intervals, which in particular prevents a malfunction of the valve device or the diaphragm due to blockage caused by prolonged use.

The valve device conveniently has a double valve that is permeable in both directions or a pressure relief valve and a separately arranged vacuum valve, which are designed as simple non-return valves. The design of the valve device as a double valve that is permeable in both directions offers the great advantage of being space-optimized compared to two individual (check) valves. Two separate valves in turn offer the advantage that comparatively simple check valves can be selected for this purpose, which are more cost-effective than a double valve that allows flow in both directions.

In a further advantageous embodiment of the expansion tank according to the invention, the lid is screwed to the tank housing. For this purpose, the lid has an external thread and the tank housing has a complementary internal thread, or vice versa, which makes it comparatively easy to replace the dryer insert, which is at least partially arranged in the lid. To do this, simply unscrew the lid from the tank housing of the expansion tank and remove the dryer insert or replace it with a new dryer insert and then screw the lid and new dryer insert back onto the tank housing of the expansion tank. A comparatively simple and inexpensive O-ring seal can be used for sealing.

Alternatively, it is of course also conceivable that the lid is not screwed into or onto the tank housing by means of a thread, but is fastened in/to the tank housing using several screws. Sealing is achieved by means of a molded seal. The lid and the dryer insert do not have to be round, but can also be rectangular.

The dryer insert is conveniently cylindrical in shape and has a cylindrical area with the drying agent and an activated carbon section that is also cylindrical in the axial direction. In this case, the area for the drying agent and the activated carbon section are therefore connected in series and flow through one after the other. Alternatively, it is also conceivable that the dryer insert has an annular cylindrical area for the drying agent and a cylindrical activated carbon section arranged therein. Such a variant can be coupled with two separate valves, which ensure that air is blown out of the expansion tank into the environment via the activated carbon section and sucked in via the drying agent.

A diaphragm is also arranged in the tank housing, which is permeable in both directions and can be located outside the dryer insert in the direction of flow. A diaphragm of this type allows both fresh air from the environment to flow into the expansion tank and air to be blown out of the expansion tank into the environment while at the same time retaining dust particles, for example. This can be used in particular to pre-filter the air sucked in from the environment through the diaphragm.

In a further preferred embodiment of the expansion tank according to the invention, a spring is provided which pretensions the dryer insert against the tank housing. A spring of this type, for example a simple coil spring, ensures that the dryer insert is held reliably and, in particular, without rattling in the lid or on the tank housing and at the same time guarantees a reliable fit.

The tank housing and lid are conveniently made of plastic. This offers the great advantage that no comparatively difficult and complex threads have to be produced on a sheet metal component, but instead, for example, an external thread on the lid and a complementary internal thread on the tank housing can be produced in a simple plastic injection molding process.

The present invention is further based on the general idea of equipping a battery cooling system with an expansion tank in accordance with the previous paragraphs and thereby transferring the advantages described with respect to the expansion tank to the battery cooling system. Specifically, this involves the advantage of a weight-reduced dryer insert and the avoidance of waste, as the actual housing of the dryer insert is now formed by the lid in the expansion tank according to the invention. The housing, in particular a plastic housing, a housing made of fleece, or a natural fiber housing, of the dryer insert serves only to fix the drying agent or the activated carbon arranged therein and can therefore not only be thin-walled, but also cost-effective, ecological, and lightweight. In particular, this means that the housing of the dryer insert, which was previously made of metal, is no longer required. The lid, which at least partially accommodates the dryer insert and can be connected, in particular screwed, to the tank housing of the expansion tank, means that a comparatively complex and therefore difficult and expensive to manufacture connection geometry on the dryer insert can be dispensed with.

Further important features and advantages of the invention are apparent from the sub-claims, from the drawings, and from the associated description of the figures with reference to the drawings.

It is understood that the features mentioned above and those to be explained below can be used not only in the combination indicated in each case, but also in other combinations or on their own, without departing from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawing.

Preferred embodiments of the invention are shown in the drawings and are explained in more detail in the following description, with identical reference signs referring to identical or similar or functionally identical components.

### BRIEF DESCRIPTION OF THE DRAWINGS

The drawings shows, schematically in each case:

FIG. 1 is a sectional view of an expansion tank according to the invention in the area of a dryer insert,

FIG. 2 is a representation as in FIG. 1, but from a different perspective,

FIG. 3 is a sectional view of a possible structure of a dryer insert,

FIG. 4 is a sectional view of an expansion tank according to the invention in the area of the dryer insert,

FIG. 5 is a representation as in FIG. 4, but with a different valve device.

### DETAILED DESCRIPTION

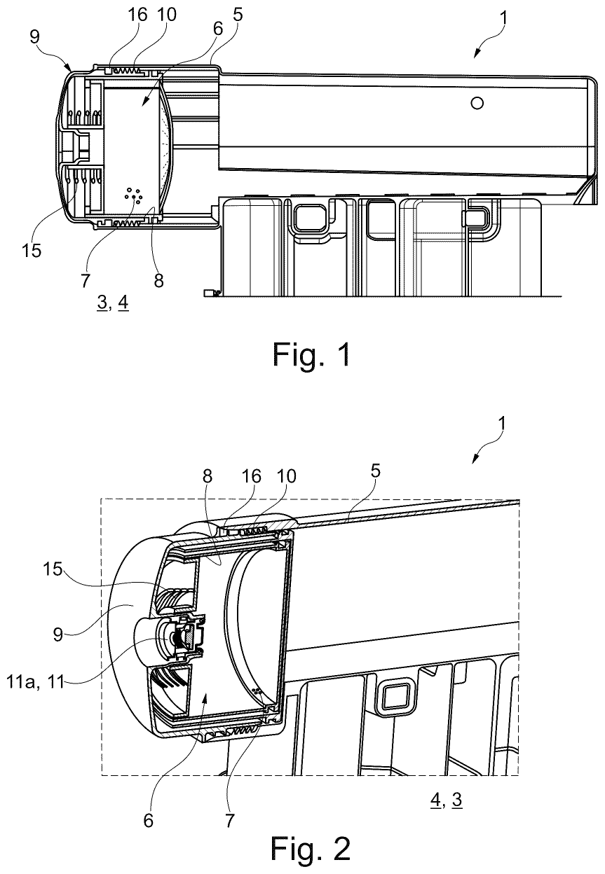

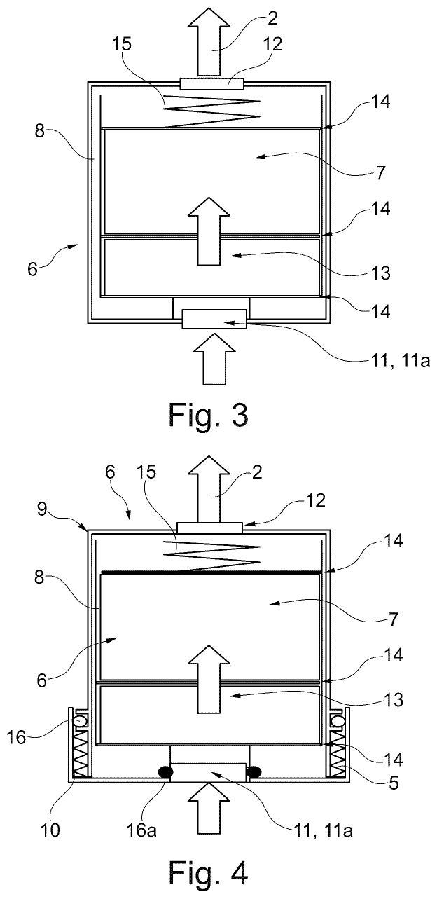

As shown in FIGS. 1, 2, 4, and 5, an expansion tank 1 according to the invention in a battery cooling system 3, in particular in an electric vehicle 4, has a tank housing 5 and a replaceable dryer insert 6 with a drying agent 7 (see also FIG. 3). The dryer insert 6 has a housing 8, in particular a plastic housing, a housing made of fleece, or a natural fiber housing, which defines a space for the drying agent 7 arranged therein. A lid 9 is also provided, which, like the tank housing 5, is made of plastic and is connected to the tank housing 5, for example via a screw connection 10 (see FIGS. 1, 2, 4, and 5). The dryer insert 6 is at least partially accommodated in the lid 9, such that the lid 9 forms a reusable outer housing for the dryer insert 6. This makes it possible to design the dryer insert 6 with a comparatively thin and weight-optimized housing 8, in particular a plastic housing, a housing made of fleece, or a natural fiber housing, and not with a comparatively thick sheet metal housing as before. The design as a natural fiber housing also offers the great advantage of being particularly ecological.

For this purpose, the lid 9 can have an external thread and the tank housing 5 a complementary internal thread, or vice versa, which makes it comparatively easy to replace the dryer insert 6 arranged at least partially in the lid 9. To do this, simply unscrew the lid 9 from the tank housing 5 of the expansion tank 1 and remove the dryer insert 6 or replace it with a new dryer insert 6 and then screw the lid 9 together with the new dryer insert 6 back onto the tank housing 5 of the expansion tank 1. Alternatively, it is of course also conceivable that the lid 9 is not connected to the tank housing 5 by means of a screw connection 10, but is fastened in/to the tank housing 5 using several screws. In this case, the lid 9 and the dryer insert 6 do not have to be round, but can also be rectangular.

A valve device 11 and/or a diaphragm 12 is/are also provided, via which air 2 can flow from the expansion tank 1 into the environment when there is excess pressure in the expansion tank 1 and fresh air 2a can flow from the environment into the expansion tank 1 when there is negative pressure in the expansion tank 1. In particular, the diaphragm 12 can be used to retain dirt particles, which can prevent contamination of a dielectric coolant in the expansion tank 1.

Looking further at the dryer insert 6 as shown in FIGS. 3 to 5, it can be seen that it has an area with the drying agent 7 and an activated carbon section 13 filled with activated carbon, wherein such activated carbon helps to retain pollutants from the air 2 to be blown out to the outside, for example hydrocarbons.

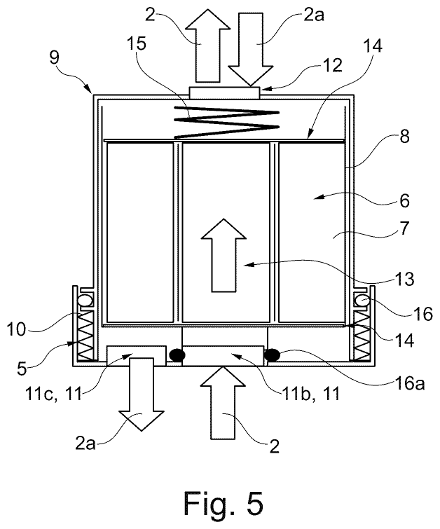

The valve device 11 can, for example, be designed as a double valve 11a that is permeable in both directions, as shown in the embodiments according to FIGS. 1 to 4, although the valve device 11 can of course also have a pressure relief valve 11b and a vacuum valve 11c, as shown in FIG. 5. The valve device 11 can open, for example, at an overpressure or under pressure of ±0.4 bar.

The valve device 11 or the diaphragm 12 can be designed and arranged in such a way that, when there is positive pressure in the expansion tank 1, air 2 only enters the environment via the activated carbon section 13 and, when there is negative pressure in the expansion tank, fresh air 2a from the environment only enters the expansion tank 1 through the drying agent 7, as shown in FIG. 5. In this case, the drying agent 7 and the activated carbon section 13 are connected in parallel. Alternatively, a series connection of the activated carbon section 13 and the drying agent 7 is of course also conceivable, as shown in FIGS. 3 and 4, such that in this case the valve device 11 and/or the diaphragm 12 can be designed and arranged in such a way that when there is excess pressure in the expansion tank 1, air 2 passes through the activated carbon section 13 and the drying agent 7 into the environment and when there is negative pressure in the expansion tank 1, fresh air 2a passes from the environment through the drying agent 7 and the activated carbon section 13 into the expansion tank 1. This offers the great advantage that when comparatively dry air 2 is blown out of the expansion tank 1 into the environment, the drying agent 7 can be dehumidified and thus regenerated. At the same time, the outgoing air 2 also flows through the activated carbon section 13, wherein hydrocarbons, for example, are retained. A separation between the drying agent 7 and the activated carbon section 13 or at least partial containment of the drying agent 7 and/or the activated carbon section 13 can be achieved by a fleece layer 14, which on the one hand reliably holds both the activated carbon in the activated carbon section 13 and the drying agent 7 in the dryer insert 6 in place and on the other hand has a low flow resistance.

Looking at the design of the drying insert 6 as shown in FIG. 3, it can be seen that the drying agent 7 and the activated carbon section 13 are connected in series and are both essentially cylindrical in shape. This also applies analogously to the embodiment shown in FIG. 4. If, on the other hand, the embodiment shown in FIG. 5 is considered, it can be seen that the drying agent 7 has a ring-cylinder shape and surrounds the activated carbon section 13, which has a cylindrical shape. A flow through the dryer insert 6 as shown in FIG. 5 takes place via the opening pressure relief valve 11b and the activated carbon section 13 as well as the diaphragm 12 into the environment when there is excess pressure in the expansion tank 1, while fresh air 2a is drawn in from the environment through the diaphragm 12 and the drying agent 7 as well as the vacuum valve 11c when there is negative pressure in the expansion tank 1.

A spring 15 secures the dryer insert 6 in the lid 9 and pretensions the dryer insert 6 against the tank housing 5.

In general, the valve device 11 and the diaphragm 12 can be arranged on the dryer insert 6, as shown in FIG. 3, although it is also conceivable that the diaphragm 12 is arranged on the lid 9 and the valve device 11 is arranged on the tank housing 5, as shown in the embodiments according to FIGS. 4 and 5. An arrangement of the valve device 11 on the lid 9 is also conceivable.

The lid 9 and the tank housing 5 are preferably made of plastic, in particular even of the same plastic, wherein an O-ring seal 16 can be provided in the area of the screw connection 10 for sealing between the lid 9 and the tank housing 5. Such an O-ring seal is cost-effective and much easier to achieve a tight seal than a pressed flat seal, as used in previous dryer cartridges. A further O-ring seal 16a can be provided, as shown in FIGS. 4 and 5, if the valve device 11 has a pressure relief valve 11b and a vacuum relief valve 11c, as shown in FIG. 5.

All in all, a significant reduction in resource consumption can be achieved with the expansion tank 1 and the battery cooling system 3 according to the invention, since the dryer insert 6 does not have a comparatively heavy housing made of sheet metal as before, but only a comparatively thin and weight-optimized housing 8, in particular a plastic housing, a housing made of fleece, or a natural fiber housing. The actual housing function is now performed by the lid 9, which as a lifetime component is not replaced when the dryer insert 6 is replaced at regular intervals. At the same time, the expansion tank 1 according to the invention eliminates the comparatively complex and therefore expensive production of a threaded nipple made of sheet metal, since the dryer insert 6 is no longer screwed directly to the tank housing 5 of the expansion tank 1. The elimination of the sheet metal housing also solves an existing corrosion problem.

1. An expansion tank for a battery cooling system, comprising:
a tank housing,
an exchangeable dryer insert with a housing and a drying agent arranged therein,
a lid that is connectable to the tank housing and in which the dryer insert is at least partially accommodated,
a valve device and/or a diaphragm, via which air passes from the expansion tank into an environment when there is an overpressure in the expansion tank and fresh air passes from the environment into the expansion tank when there is a vacuum in the expansion tank.

2. The expansion tank according to claim 1, wherein the dryer insert has an activated carbon section.

3. The expansion tank according to claim 2, wherein:
the valve device and/or the diaphragm is structured and arranged such that, in the event of excess pressure prevailing in the expansion tank, air passes via the activated carbon section into the environment and, in the event of negative pressure prevailing in the expansion tank, fresh air passes from the environment through the drying agent into the expansion tank, or
the valve device and/or the diaphragm is structured and arranged such that, when there is excess pressure in the expansion tank, air passes via the activated carbon section and the drying agent into the environment and, when there is negative pressure in the expansion tank, fresh air passes from the environment through the drying agent and the activated carbon section into the expansion tank.

4. The expansion tank according to claim 2, wherein the drying agent and/or the activated carbon section are bounded by a fleece layer and/or the housing has a fleece layer.

5. The expansion tank according to claim 1, wherein the valve device and/or the diaphragm is arranged on the dryer insert or on the tank housing.

6. The expansion tank according to claim 1, wherein the valve device has a double valve that is permeable in both directions or a pressure relief valve and a vacuum valve.

7. The expansion tank according to claim 1, wherein the lid is screwed to the tank housing.

8. The expansion tank according to claim 2, wherein:
the dryer insert is cylindrical in shape and has the activated carbon section which is cylindrical in shape and adjoins the dryer insert in the axial direction, or
the dryer insert is structured in the shape of a ring cylinder with the activated carbon section located on the inside and structured in the shape of a cylinder.

9. The expansion tank according to claim 1, further comprising a spring that pretensions the dryer insert against the tank housing.

10. The expansion tank according to claim 1, wherein the tank housing and the lid are composed of plastic.

11. The expansion tank according to claim 1, wherein the housing is structured as a plastic housing, a fleece housing, or a natural fiber housing.

12. A battery cooling system, comprising: an expansion tank, the expansion tank including:
a tank housing,
an exchangeable dryer insert with a housing and a drying agent arranged therein,
a lid that is connectable to the tank housing and in which the dryer insert is at least partially accommodated,
a valve device and/or a diaphragm, via which air passes from the expansion tank into an environment when there is an overpressure in the expansion tank and fresh air passes from the environment into the expansion tank when there is a vacuum in the expansion tank.

13. The battery cooling system according to claim 12, wherein the dryer insert has an activated carbon section.

14. The battery cooling system according to claim 13, wherein the valve device and/or the diaphragm is structured and arranged such that, in the event of excess pressure prevailing in the expansion tank, air passes via the activated carbon section into the environment and, in the event of negative pressure prevailing in the expansion tank, fresh air passes from the environment through the drying agent into the expansion tank.

15. The battery cooling system according to claim 13, wherein the valve device and/or the diaphragm is structured and arranged such that, when there is excess pressure in the expansion tank, air passes via the activated carbon section and the drying agent into the environment and, when there is negative pressure in the expansion tank, fresh air passes from the environment through the drying agent and the activated carbon section into the expansion tank.

16. The battery cooling system according to claim 13, wherein the drying agent and/or the activated carbon section are bounded by a fleece layer and/or the housing has a fleece layer.

17. The battery cooling system according to claim 12, wherein the valve device and/or the diaphragm is arranged on the dryer insert or on the tank housing.

18. The battery cooling system according to claim 12, wherein the valve device has a double valve that is permeable in both directions or a pressure relief valve and a vacuum valve.

19. The battery cooling system according to claim 12, wherein the lid is screwed to the tank housing.

20. The battery cooling system according to claim 12, further comprising a spring that pretensions the dryer insert against the tank housing.
